(19) United States
(12) Patent Application Publication
(10) Pub. No.: US 2005/0230875 A1
(43) Pub. Date: Oct. 20, 2005

(54) Forming machine and method of forming material

(75) Inventors: Alan G. Miller, South Easton, MA (US); Dan Ruben Free, Manitowoc, WI (US); George Howard Pool, Manitowoc, WI (US)

Correspondence Address: WILMER CUTLER PICKERING HALE AND DORR LLP, 60 STATE STREET, BOSTON, MA, 02109, US

(73) Assignee: Risco USA Corporation, South Easton, MA (US)

(21) Appl. No.: 11/106,046

(22) Filed: Apr. 14, 2005

Related U.S. Application Data
(60) Provisional application No. 60/563,178, filed on Apr. 16, 2004.

(51) Int. Cl. B29C 35/12

(52) U.S. Cl. 264/177.11; 425/149

(57) ABSTRACT

A forming machine includes a ram cylinder, a ram, the ram cylinder and a forward end of the ram defining a closed chamber, and an inlet to and an outlet from the closed chamber. A method of forming material is also disclosed.

### CROSS-REFERENCE TO RELATED APPLICATION

This application claims priority from provisional Ser. No. 60/563,178 filed Apr. 16, 2004, which is incorporated herein by reference.

### BACKGROUND AND SUMMARY

The present invention relates to a forming machine and a method of forming material and, more particularly, to a forming machine and method.

Typical known forming machines, such as those used for making meat patties, include a pressure chamber or ram cylinder disposed beneath and opening directly into the bottom of a hopper for holding material to be formed. When a ram is pulled back in the cylinder, devices such as augers force material into the cylinder ahead of the ram. The ram advances and closes flow communication between the cylinder and the hopper so that the ram and the cylinder define a chamber that is closed except for an outlet opening and pressurizes the material in the chamber so that it is forced out of the outlet opening. In patty forming applications, the outlet opening ordinarily leads to a volume defined by an opening in a forming plate and upper and lower surfaces between which the forming plate moves. The opening in the forming plate is often substantially circular, but may be any desired shape for forming portions of different shapes. Once full, the forming plate is moved so that the opening is positioned beneath a knockout device that knocks the patty out of the opening, usually onto a waiting conveyor apparatus below. U.S. Pat. No. 4,153,974 is an example of such a molding device.

In these types of apparatus, each time it is desired to form an object such as a patty, the ram must be withdrawn to a position where the cylinder is again open to the hopper so that more material can be forced into the cylinder. Wear and tear on such a device can be substantial. Also, when the cylinder is opened to the hopper each time that it is desired to load the cylinder with material to be formed, there is an increased possibility of air-borne contaminants entering the system, which can be quite problematic in food-based applications. It is desirable to minimize contact of the material to be portioned and formed with air once the material has entered the system.

In accordance with an aspect of the present invention, a forming machine includes a ram cylinder and a ram, with the ram cylinder and a forward end of the ram defining a closed chamber, together with an inlet to and an outlet from the closed chamber.

In accordance with another aspect of the present invention, a method of forming material includes advancing a ram from a starting position to an ending position in a ram cylinder so that material to be formed is forced out of an outlet in the cylinder, returning the ram from the ending position to the starting position, and, while returning the ram from the ending position to the starting position, introducing material to be formed into the ram cylinder through an inlet. The ram and the ram cylinder define a closed chamber as the ram travels between the starting position and the ending position, the inlet and the outlet extending to and from the closed chamber, respectively.

### BRIEF DESCRIPTION OF THE DRAWINGS

The features and advantages of the present invention are well understood by reading the following detailed description in conjunction with the drawings in which like numerals indicate similar elements and in which:

FIG. 1 is a schematic, partially cross-sectional view of a forming machine according to an embodiment of the present invention;

FIG. 2 is a schematic, partially cross-sectional view of a forming machine according to an embodiment of the present invention; and

FIG. 3 is a schematic, partially cross-sectional view of the forming machine of FIG. 1 showing the ram in a different position.

### DETAILED DESCRIPTION

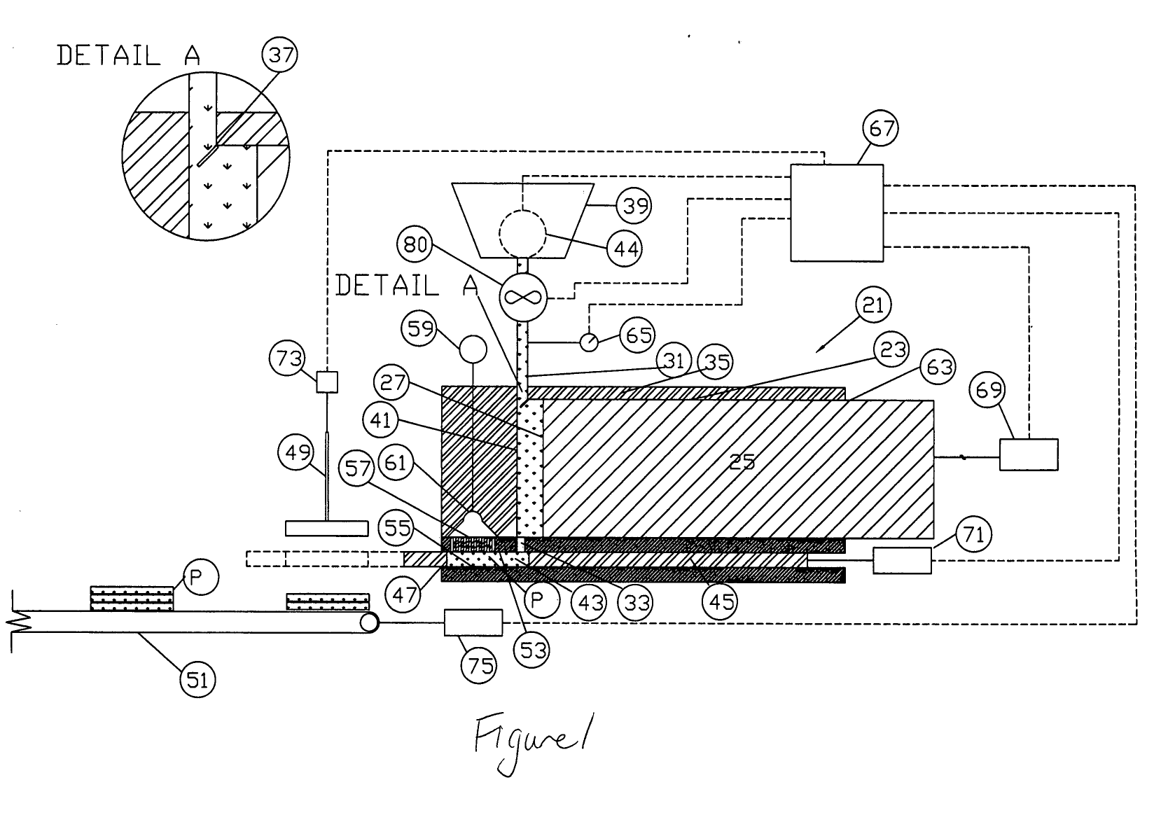

A forming machine 21 according to an embodiment of the present invention is shown in FIG. 1. The forming machine 21 includes a ram cylinder 23 and a ram 25. The ram cylinder 23 and a forward end 27 of the ram 25 define a closed chamber 29 that is variable in size as the ram moves in the ram cylinder. There is an inlet 31 to and an outlet 33 from the closed chamber 29 and thus, a special definition for the word “closed” as used in the context of describing the chamber 29 as being closed means that it is closed except to the extent that the inlet and the outlet lead to and from the chamber. The forming machine 21 will generally be described in connection with an application for forming products such as meat patties, it being understood, however, that the forming machine has numerous other applications.

In the forming machine shown in FIG. 1, the inlet 31 is formed in a wall 35 of the ram cylinder 23. The inlet 31 includes a door 37 that is adapted to open and close, such as a hinged door or a flap or a valve. A source 39 of pressurized material M such as ground meat to be formed is preferably connected to the inlet 31 and, when the ram 25 is moved away from an ending position in the cylinder 23 at or near the top end 41 of the cylinder, the door 37 opens under a force applied by the material to be formed in the source of material which is at an equal or greater pressure than the chamber 29. When the ram 25 moves toward the top position in the cylinder 23, the door 37 closes under force applied by the material to be formed in the cylinder. If desired or necessary, other one-way arrangements than the hinged door 37 can be used.

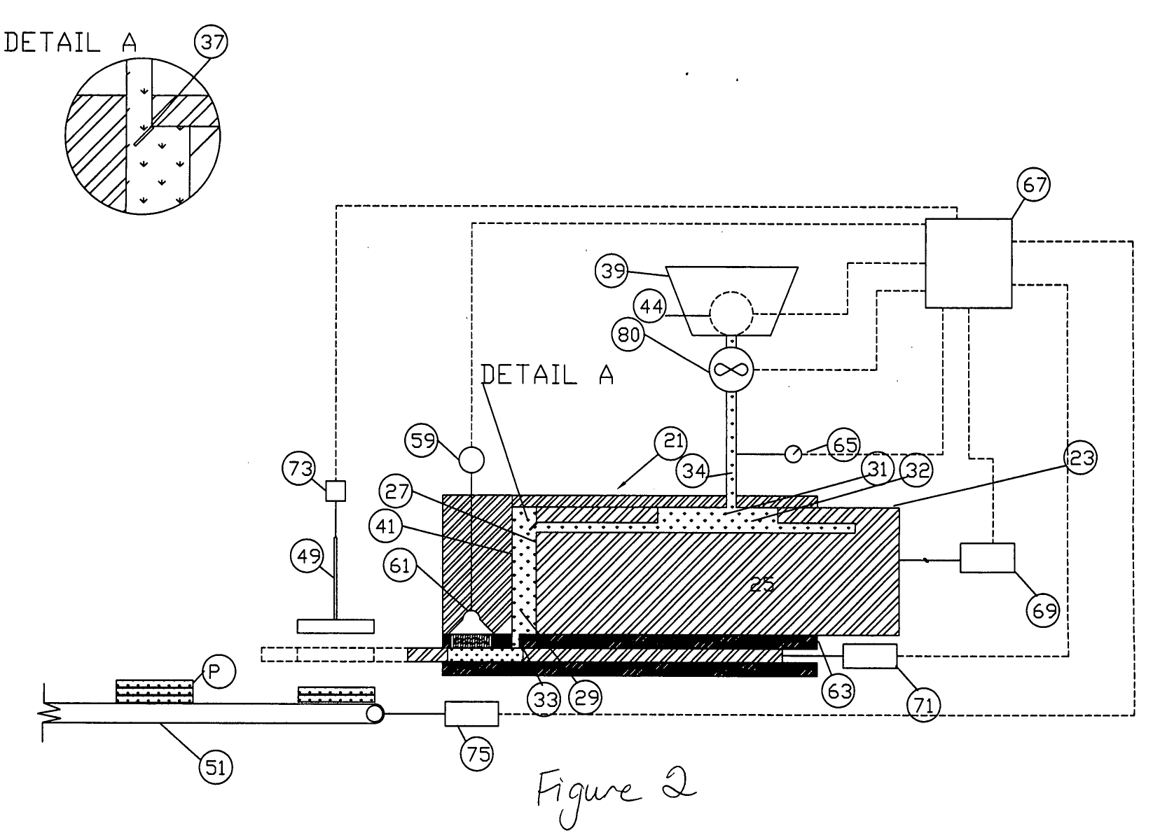

FIG. 2 shows another embodiment of a forming machine 21′ wherein the inlet 31′ is formed in a forward end 27′ of the ram 25′. Material M to be formed can be introduced to a channel 32′ leading to the inlet 31′ in any suitable fashion, such as by a flexible connection 34′ attached to a portion of the ram or through an appropriate inlet valve communicating with the channel 32′. A door 37′ such as a flap or door arrangement or a suitable one-way valve is preferably provided for preventing material M to be formed from flowing out of the chamber 29′ through the inlet 25′.

The embodiment of FIG. 1 will be used to describe the operation except where otherwise indicated, it being understood that the description is equally applicable to the embodiment of FIG. 2. The source 39 of pressurized material M to be formed is connected to the inlet 31, and a volume 43 for receiving a portion P of material is connected to the outlet 33. After the source 39 of pressurized material M to be formed receives material to be formed, e.g., meat in large chunks in a hopper/grinder, and pressurizes the material to be formed, preferably using a rotary-type pump 44 of the type described in U.S. Pat. No. 4,313,240, the disclosure of which is incorporated by reference, the forming machine 21 is preferably arranged such that the material to be formed does not contact air until it is removed from the volume 43. If desired or necessary, however, other suitable pumps can be used as well, such as screw-type pumps.

In a forming machine 21 of the type for forming, e.g., meat patties, a forming plate 45 having an opening 47 therein is moved from a position in which the opening is in flow communication with the outlet 33 and receives a portion of material M to form a portion P to a position in which the opening is beneath a reciprocating punch-type device 49 that punches the portion out of the opening, usually onto a conveyor 51 or a stack of other portions on a conveyor. The opening 47, together with usually fixed upper and lower surfaces 53 and 55 of the forming machine 21, defines the volume 43. At least one of the upper and lower surfaces 53 and 55 preferably has air evacuation holes 57 formed therein to permit air in the volume 43 to exit as the portion P is forced in. As described in provisional application No. 60/563,179, filed Apr. 16, 2004, which is incorporated herein by reference, a vacuum-type device 59 is preferably arranged to communicate with a volume 61 communicating with the holes 57 so that air does not contact the material M.

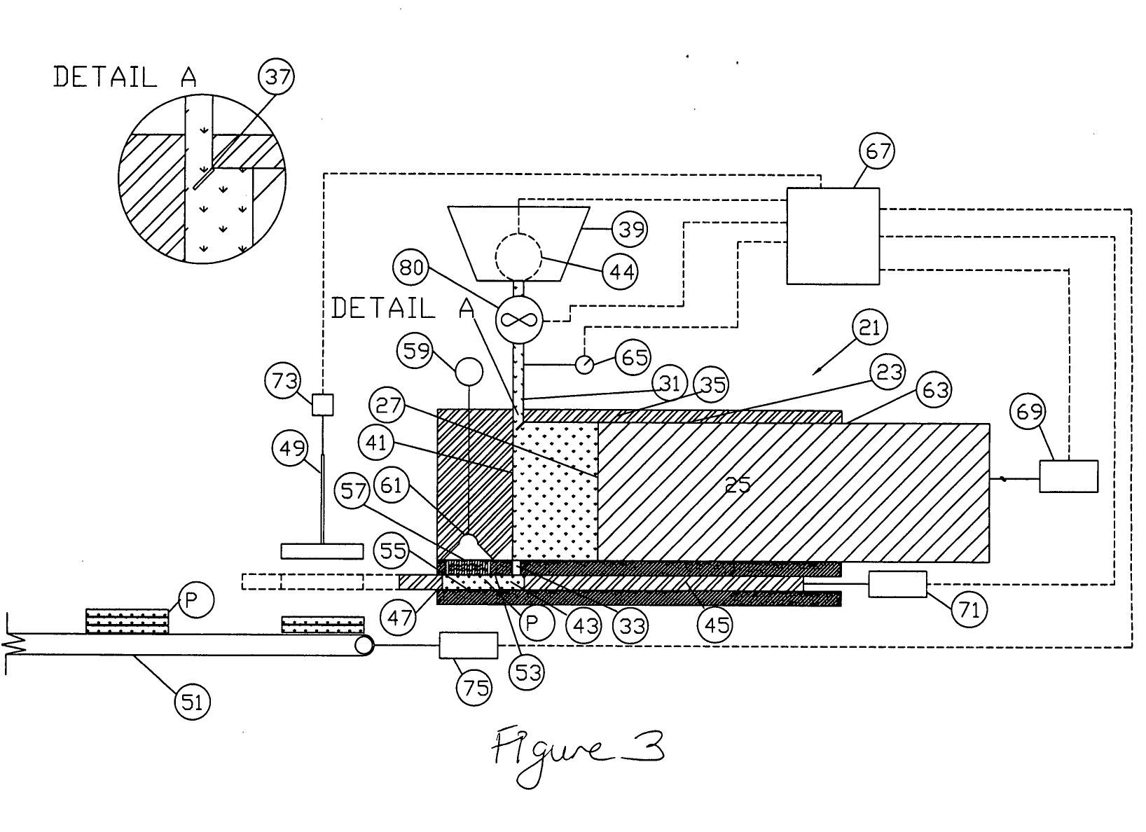

The ram 25 is indexable to a plurality of different positions in the cylinder 23. The ram 25 will intermittently advance to successive indexed positions to make a predetermined plurality of portions P, e.g., meat patties to be stacked, upon being filled with a desired amount of material M to be formed. Preferably, at an ending point of the advance of the ram 25, the forward end 27 of the ram will be at or very near the forward end 41 of the ram cylinder 23, thus tending to minimize wasted material and simplify clean-up. Once the predetermined quantity of portions P are formed, e.g., a stack of a desired number of meat patties has been positioned on the conveyor 51, the conveyor 51 advances and, preferably simultaneously with the advance of the conveyor, the ram 25 is moved from the ending point of the ram's advance to a starting point nearer an open end 63 of the ram cylinder 23, as seen in FIG. 3. The location of the starting point depends upon how much material M is to be added to the chamber 29, which is preferably equal to the amount of material M necessary to form the predetermined plurality of portions P. Preferably, as the ram 25 is moved from the ending point to the starting point, the door, i.e., door, flap, valve, etc., opens automatically, such as due to pressure from the material M from the source 39 of pressurized material being greater than the pressure in the chamber 29.

The source 39 of pressurized material M to be formed preferably includes a pressure sensor 65 for sensing pressure of the material to be formed in a conduit 34 leading to the inlet 31. The pressure sensor 65 sends a signal that indicates that the pressure of the material M to be formed is at a predetermined pressure. The signal from the pressure sensor 65 is received by a controller 67 that stops the source of pressurized material 39 from delivering additional pressurized material to be formed to the inlet, such as by stopping the pump 44. The controller 67 preferably also controls operation of a drive 69 for the ram 25, a drive 71 for the forming plate 45, a drive 73 for the punch-type device 49, and a drive 75 for the conveyor 51. Any suitable type of drive can be used for the drives 69, 71, 73, and 75, however, the ram drive 69 is preferably a hydraulic or pneumatic drive, and the conveyor drive 75 preferably includes an electric motor. The ram drive 69 is preferably adapted to be controlled to index the ram 25 to different positions.

In a method of forming material according to the present invention, the ram 25 is advanced from a starting position to an ending position in the ram cylinder 23 so that material M to be formed is forced out of the outlet 33 in the cylinder. The ram 25 is then returned from the ending position to the starting position. While returning the ram 25 from the ending position to the starting position, material M to be formed is introduced into the cylinder 23 through the inlet 31. The ram 25 and the ram cylinder 23 define the closed chamber 29 as the ram travels between the starting position and the ending position, with the inlet 31 and the outlet 33 extending to and from the closed chamber, respectively. The inlet 31 preferably closes when the ram 25 travels from the starting position to the ending position. The outlet 33 preferably least intermittently communicates with the volume 61 that is maintained at a lower pressure than the chamber 29.

The ram 25 is preferably intermittently advanced from the starting position to the ending position to form a plurality of successive portions P when material M to be formed is forced out of the outlet 33 in the cylinder 23, and the portions are preferably arranged in one or more stacks of one or more portions on a conveyor 51. The one or more stacks are preferably conveyed on the conveyor 51 when the ram 25 is returned from the ending position to the starting position.

While this invention has been illustrated and described in accordance with a preferred embodiment, it is recognized that variations and changes may be made therein without departing from the invention as set forth in the claims.

1. A forming machine, comprising:
a ram cylinder;
a ram, the ram cylinder and a forward end of the ram defining a closed chamber; and
an inlet to and an outlet from the closed chamber.

2. The forming machine as set forth in claim 1, wherein the inlet is formed in a wall of the ram cylinder.

3. The forming machine as set forth in claim 2, wherein the inlet includes a door that is adapted to open and close.

4. The forming machine as set forth in claim 3, further comprising a source of pressurized material to be formed connected to the inlet, wherein, when the ram is moved away from a top position in the cylinder, the door opens under a force applied by the material to be formed in the source of material and, when the ram moves toward the top position in the cylinder, the door closes under force applied by the material to be formed in the cylinder.

5. The forming machine as set forth in claim 1, wherein the inlet is formed in the forward end of the ram.

6. The forming machine as set forth in claim 1, further comprising a one-way valve for preventing material to be formed from flowing out of the chamber through the inlet.

7. The forming machine as set forth in claim 1, further comprising a source of pressurized material to be formed connected to the inlet, and a volume for receiving a portion of material connected to the outlet, and wherein the source of pressurized material to be formed is adapted to receive material to be formed and to pressurize the material to be formed and, after the material to be formed is pressurized, the forming machine is arranged such that the material to be formed does not contact air until it is removed from the volume.

8. The forming machine as set forth in claim 1, further comprising a valve for preventing material to be formed from flowing out of the chamber through the inlet.

9. The forming machine as set forth in claim 1, further comprising a vacuum arranged to at least intermittently be in flow communication with the outlet to prevent air from entering the chamber.

10. The forming machine as set forth in claim 1, wherein the ram is indexable to a plurality of different positions in the cylinder.

11. The forming machine as set forth in claim 1, further comprising a source of pressurized material to be formed connected to the inlet, a volume, the volume including a mold portion, for receiving a portion of material connected to the outlet, and a stacker for stacking portions of material after they are ejected from the mold portion.

12. The forming machine as set forth in claim 11, wherein the ram is indexable to a plurality of different positions in the cylinder between a starting point and an ending point and the ram is adapted to be set to travel between the starting point and the ending point a distance corresponding to a number of portions to be stacked.

13. The forming machine as set forth in claim 12, wherein, beginning at the starting point, the ram is indexable a plurality of times to form a corresponding plurality of portions and, after stacking a predetermined number of portions into a stack, the stacker is movable to move the stack and the ram is arranged to return to the starting point while the stacker moves the stack.

14. The forming machine as set forth in claim 13, wherein the source of pressurized material is arranged to deliver material to be formed to the chamber as the ram returns to the starting position.

15. The forming machine as set forth in claim 1, further comprising a source of pressurized material to be formed connected to the inlet and a pressure sensor for sensing pressure of the material to be formed, the pressure sensor being adapted to send a signal indicating that the pressure of the material to be formed is at a predetermined pressure, the signal from the pressure sensor being received by a controller that stops the source of pressurized material from delivering additional pressurized material to be formed to the inlet.

16. The forming machine as set forth in claim 15, wherein the source of pressurized material to be formed includes a pump for pressurizing material to be formed and delivering the pressurized material to the inlet, the controller being arranged to stop the pump in response to the signal from the pressure sensor.

17. A method of forming material, comprising:
advancing a ram from a starting position to an ending position in a ram cylinder so that material to be formed is forced out of an outlet in the cylinder;
returning the ram from the ending position to the starting position; and
while returning the ram from the ending position to the starting position, introducing material to be formed into the rain cylinder through an inlet, wherein the ram and the ram cylinder define a closed chamber as the ram travels between the starting position and the ending position, the inlet and the outlet extending to and from the closed chamber, respectively.

18. The method of forming material as set forth in claim 17, comprising closing the inlet when the ram travels from the starting position to the ending position.

19. The method of forming material as set forth in claim 18, comprising causing the outlet to at least intermittently communicate with a volume that is maintained at a lower pressure than the chamber.

20. The method of forming material as set forth in claim 17, comprising causing the outlet to at least intermittently communicate with a volume that is maintained at a lower pressure than the chamber.

21. The method of forming material as set forth in claim 17, wherein the ram is intermittently advanced from the starting position to the ending position.

22. The method of forming material as set forth in claim 17, comprising forming one or more portions when material to be formed is forced out of the outlet in the cylinder, and arranging the one or more portions in one or more stacks of one or more portions on a conveyor.

23. The method of forming material as set forth in claim 22, comprising conveying the one or more stacks on the conveyor when the ram is returned from the ending position to the starting position.
